(19) United States
(12) Patent Application Publication
(10) Pub. No.: US 2008/0253368 A1
(43) Pub. Date: Oct. 16, 2008

(54) Policy control of multiplexed real time protocol and real time control protocol

(75) Inventor: Juha Rasanen, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Siemens Networks Oy

(21) Appl. No.: 12/078,925

(22) Filed: Apr. 8, 2008

Related U.S. Application Data
(60) Provisional application No. 60/907,627, filed on Apr. 11, 2007.

(51) Int. Cl. H04L 12/56

(52) U.S. Cl. 370/389

(57) ABSTRACT

A system can include an application function which is configured to indicate per each multiplexed flow to a rules function that a flow includes multiplexed real time protocol data packets and control packets flow and to indicate the status of each component of the multiplexed flow. The rules function can be configured to inform an enforcement function which is configured to detect the multiplexed flows by the IP addresses and port numbers and to detect the multiplexed subcomponents. The enforcement function can be configured to apply separate gating to data packets and control packets according to the status of each subcomponent.

### BACKGROUND OF THE INVENTION

1. Field of the Invention

The present invention relates to policy and charging control and to the multiplexed use of real time protocol data packets and control packets on a port.

2. Description of the Related Art

A real time protocol (RTP) session includes data packets and real time control protocol (RTCP) packets. The RTCP packets are assumed to be distributed in the same manner as the data packets. Therefore, the underlying protocol provides multiplexing of the data packets and control packets, for example by using separate port numbers with user datagram protocol (UDP). When this approach is used, the multiplexing is deferred to the underlying transport protocol, rather than being provided within the real time protocol. While this approach may be used for various real time protocol applications, it may be problematic, for example, in cases where many real time protocol deployments do not use internet protocol (IP) multicast. Furthermore, with the increased use of Network Address Translation (NAT), the simplicity of multiplexing at the transport layer is a liability, because it requires complex signaling to open multiple NAT pinholes. In these environments, an alternative to de-multiplexing real time data packets and control packets using separate UDP ports, is to use only a single UDP port and de-multiplexing the real time data packets and control packets within the application.

When real time data packets and control packets are multiplexed on the same port, that is, by using the same port number, there is no means for policy and charging control and enforcement elements to separate the real time control packet flows from the real time data packet flows. Therefore, the real time data packet flow cannot be put on hold without preventing/blocking also the real time control packet flow. However, maintaining the real time control packet flow is vital for many reasons, for example, for the RTP protocol, and for possible “keep-alive” purposes.

### SUMMARY OF THE INVENTION

An embodiment of the present invention is therefore directed to a method including providing a request comprising a predefined attribute to indicate real time protocol data packets and control packets that are to be multiplexed onto a single port. The method also includes receiving an answer indicating that multiplexed real time protocol data packets and control packets are to be processed according to the predefined attribute.

Another embodiment is directed to an apparatus including a transmitter configured to send a request comprising a predefined attribute to indicate real time protocol data packets and control packets to be multiplexed onto a single port. The apparatus also includes a receiver configured to receive an answer indicating that multiplexed real time protocol data packets and control packets are to be processed according to the predefined attribute.

Another embodiment of the invention is directed to a computer program embodied on a computer readable medium, the computer program being configured to control a processor to perform a method including providing a request comprising a predefined attribute to indicate real time protocol data packets and control packets to be multiplexed onto a single port. The method also includes receiving an answer indicating that multiplexed real time protocol data packets and control packets are to be processed according to the predefined attribute.

Another embodiment of the invention is directed to an apparatus including sending means for sending a request comprising a predefined attribute to indicate real time protocol data packets and control packets to be multiplexed onto a single port. The apparatus also includes receiving means for receiving an answer indicating that multiplexed real time protocol data packets and control packets are to be processed according to the predefined attribute.

Another embodiment of the invention is directed to a method including receiving a request message indicating flow multiplexing from a user equipment and sending the request message to a called party. The method also includes receiving a response message from the called party indicating flow multiplexing and forwarding the response message to the user equipment. The method also includes detecting real time protocol data packets and control packets to be multiplexed on a single port. The method also includes sending session information with flow multiplexing information and multiplexed flow status information to a rules function to apply gating and policy and charging rules.

Another embodiment of the invention is directed to an apparatus including a receiver configured to receive a request message indicating flow multiplexing from a user equipment. The apparatus also includes a transmitter configured to transmit the request message to a called party. The receiver is configured to receive a response message from the called party indicating flow multiplexing. The transmitter is configured to the response message to the user equipment. The apparatus also includes a detector configured to detect real time protocol data packets and control packets to be multiplexed on a single port. The transmitter is configured to send session information with flow multiplexing information and multiplexed flow status information to a rules function to apply gating and policy and charging rules.

Another embodiment of the invention is directed to a computer program embodied on a computer readable medium, the computer program being configured to control a processor to perform a method including receiving a request message indicating flow multiplexing from a user equipment. The method also includes sending the request message to a called party. The method also includes receiving a response message from the called party indicating flow multiplexing. The method also includes forwarding the response message to the user equipment. The method also includes detecting real time protocol data packets and control packets to be multiplexed on a single port. The method also includes sending session information with flow multiplexing information and multiplexed flow status information to a rules function to apply gating and policy and charging rules.

Another embodiment of the invention is directed to an apparatus including receiving means for receiving a request message indicating flow multiplexing from a user equipment. The apparatus also includes sending means for sending the request message to a called party. The receiving means receives a response message from the called party indicating flow multiplexing. The apparatus also includes forwarding means for forwarding the response message to the user equipment. The apparatus also includes detecting means for detecting real time protocol data packets and control packets to be multiplexed on a single port. The sending means sends session information with flow multiplexing information and multiplexed flow status information to a rules function to apply gating and policy and charging rules.

Another embodiment of the invention is directed to a method including receiving session information with flow multiplexing information and multiplexed flow status information from an application function. The method also includes sending policy and charging rules with flow multiplexing information and multiplexed flow status information to an enforcement function.

Another embodiment of the invention is directed to an apparatus including a receiver configured to receive session information with flow multiplexing information and multiplexed flow status information from an application function. The apparatus also includes a transmitter configured to send policy and charging rules with flow multiplexing information and multiplexed flow status information to an enforcement function.

Another embodiment of the invention is directed to a computer program embodied on a computer readable medium, the computer program being configured to control a processor to perform a method including receiving session information with flow multiplexing information and multiplexed flow status information from an application function. The method also includes sending policy and charging rules with flow multiplexing information and multiplexed flow status information to an enforcement function.

Another embodiment of the invention is directed to an apparatus including receiving means for session information with flow multiplexing information and multiplexed flow status information from an application function. The apparatus also includes sending means for sending policy and charging rules with flow multiplexing information and multiplexed flow status information to an enforcement function.

Another embodiment of the invention is directed to a method including receiving information from policy charging rules function. The method also includes processing flows based on the information. The information comprises information differentiating real time protocol and real time control protocol within a multiplexed flow.

Another embodiment of the invention is directed to an apparatus including a receiver configured to receive information from policy charging rules function. The apparatus also includes a processor configured to process flows based on the information. The information comprises information differentiating real time protocol and real time control protocol within a multiplexed flow.

Another embodiment of the invention is directed to a computer program embodied on a computer readable medium, the computer program being configured to control a processor to perform a method including receiving information from policy control rules function. The method also includes processing flows based on the information. The information comprises information differentiating real time protocol and real time control protocol within a multiplexed flow.

Another embodiment of the invention is directed to an apparatus including receiving means for receiving information from policy control rules function. The apparatus also includes processing means for processing flows based on the information. The information comprises information differentiating real time protocol and real time control protocol within a multiplexed flow.

Another embodiment of the invention is directed to a system including an application function configured to indicate per each multiplexed flow to a rules function that a flow includes multiplexed real time protocol data packets and control packets flow and to indicate the status of a component of the multiplexed flow. The rules function is configured to inform an enforcement function that is configured to detect the multiplexed flows by internet protocol addresses and port numbers and to detect the multiplexed subcomponents. The enforcement function is configured to apply separate gating to data packets and control packets according to the status of each subcomponent.

It should be appreciated by one skilled in art, that the present invention may be utilized in any device that implements the multiplexing of real time data and control packets described above. The foregoing description has been directed to specific embodiments of this invention. It will be apparent; however, that other variations and modifications may be made to the described embodiments, with the attainment of some or all of their advantages.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an embodiment of an overall policy and charging control logical architecture;

FIG. 2 illustrates an embodiment of a signalling scenario of a session establishment with flow multiplexing.

FIG. 3 illustrates an embodiment of the Diameter Attribute Value Pairs defined for an Rx interface protocol.

FIG. 4 illustrates a flow chart including providing a request including a predefined attribute to indicate real time protocol data packets and control packets that are to be multiplexed onto a single port.

FIG. 5 illustrates a flow chart including receiving a request message indicating flow multiplexing from a user equipment, in accordance with and embodiment of the present invention.

FIG. 6 illustrates a flow chart including receiving session information with flow multiplexing information and multiplexed flow status information from an application function, in accordance with and embodiment of the present invention.

FIG. 7 illustrates a flow chart including receiving information from policy charging rules function, in accordance with and embodiment of the present invention.

FIG. 8 illustrates an apparatus in accordance with an embodiment of the present invention.

FIG. 9 illustrates an apparatus in accordance with an embodiment of the present invention.

FIG. 10 illustrates an apparatus in accordance with an embodiment of the present invention.

FIG. 11 illustrates an apparatus in accordance with an embodiment of the present invention.

### DETAILED DESCRIPTION OF PREFERRED EMBODIMENTS

Reference will now be made to the preferred embodiments of the present invention, examples of which are illustrated in the accompanying drawings.

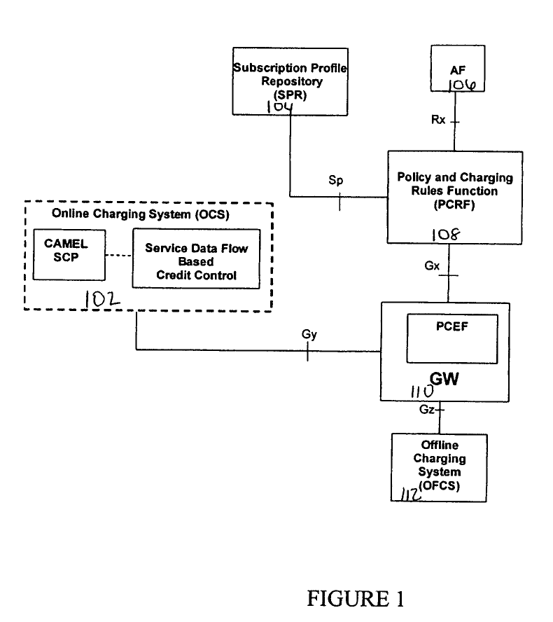

FIG. 1 illustrates an embodiment of an overall policy and charging control (PCC) logical architecture. The architecture illustrated in FIG. 1 extends the architecture of an IP Connectivity Access Network (IP-CAN) and the components of FIG. 1 may be used when real time protocol data packets and control packets are multiplexed to a single port. The architecture includes an online charging system 102, a subscription profile repository 104, an application function 106, a policy charging and rules function (PCRF) 108, a policy and charging enforcement function (PCEF) 110 and an offline charging system (OFCS) 112. In order to allow for charging control, information in the PCC rules identifies service data flow and specifies the parameters for charging control. The policy control features include gating controls and Quality of Service (QoS) controls. The term “gating” or “gating control” is directed to the blocking or allowing of packets, belonging to a service data flow, to pass through to a desired endpoint. Parameters exchanged between components of the architecture may also be used for indicating that real time protocol data packets and control packets are to be multiplexed to a single port.

The subscription profile repository 104 includes all subscriber/subscription related information needed for subscription-based PCC rules. Application function 106 is an element offering applications that require dynamic policy and/or charging control over the user plane behaviour. Application function 106 communicates with PCRF 108 to transfer dynamic session information required for PCRF decisions, as well as, specific information and notifications about bearer level events.

PCRF 108 includes policy control decision and flow based charging control functions. Specifically, PCRF 108 provides network control regarding service data flow detection, gating, QoS and flow based charging (except credit management) towards PCEF 110. PCRF 108 also applies security procedures, as required by an operator, before accepting service information from application function 106 and PCRF 108 decides how a certain service data flow shall be treated in PCEF 110 and ensures that PCEF 110 user plane traffic mapping and treatment is in accordance with the user's subscription profile.

PCEF 110 includes service data flow detection, policy enforcement and flow based charging functionalities. Specifically, PCEF 110 provides service data flow detection, user plane traffic handling, triggering control plane session management, where permitted, QoS handling, and service data flow measurement, as well as, online and offline charging interactions. PCEF 110 ensures that an IP packet that is discarded at the PCEF as a result of policy enforcement or flow based charging is not reported for offline charging and that it does not cause credit consumption for online charging. PCEF 110 enforces policy control as indicated by PCRF 108 through gate enforcement or QoS enforcement.

The Rx interface between application function 106 and PCRF 108 enables the transport of application level session information from application function 106 to PCRF 108. The Gx interface enables the signalling of PCC decision, which governs the PCC behaviour, and it supports the initialisation and maintenance of connection, requests for PCC decision from PCEF 110 to PCRF 108, provision of PCC decision from PCRF 108 to PCEF 110, negotiation of IP-CAN bearer establishment mode and termination of connection. The Sp interface allows PCRF 108 to request subscription information related to the IP-CAN transport level policies from the SPR based on a subscriber ID and other predefined information. The Gy interface allows online credit control for service data flow based charging. The Gz interface enables the transport of service data flow based offline charging information.

The procedures for multiplexing real time data packets and control packets on a single port depend on whether a session is a unicast session or a multicast session. For multicast sessions, the procedures also depend on whether any source multicast (ASM) or single source multicast (SSM) is to be used. For unicast sessions, it is acceptable to multiplex real time data packets and control packets on a single User Datagram Protocol (UDP) port to ease Network Address Translation (NAT) traversal for the unicast sessions, provided the RTP payload types used in the session are chosen according to predefined rules and provided that multiplexing is signalled in advance. Such multiplexed sessions can be signalled using the Session Initiation Protocol (SIP) with the offer/answer model.

In an embodiment of the invention, when the Session Description Protocol (SDP) is used to negotiate real time protocol sessions following the offer/answer model, an “a=rtcp−mux” attribute indicates the desire to multiplex real time protocol data packets and control packets onto a single port. The initial SDP offer includes the “a=rtcp−mux” attribute to request multiplexing of RTP and RTCP on a single port. If a responder wishes to multiplex RTP and RTCP onto the single port, the responder includes an “a=rtcp−mux” attribute in an answer. The RTP payload types used in the answer conform to the predefined rules.

If the answer does not contain the “a=rtcp−mux” attribute, the requestor/sender may not multiplex RTP and RTCP packets on the single port. Instead, the requestor sends and receives RTCP on a port allocated according to the usual port selection rules.

When SDP is used in declarative manner outlined above, the presence of the “a=rtcp−mux” attribute signals that the sender/requestor will multiplex RTP and RTCP on the same port. The receiver is thus prepared to receive RTCP packets on the RTP port, and to make any resource reservation, including for the RTCP bandwidth.

When a SIP/IMS session is established and the multiplexing of RTP and RTCP is indicated in the SDP offer/answer signalling, application function 106 protocol/Proxy call state control function (AF/P-PCSF) indicates per each multiplexed flow to PCRF 108 that the flow includes multiplexed real time protocol data packets and control packets flow. AF/P-PCSF also indicates the status of each component (RTP and RTCP) of the multiplexed flow, for example the “RTP enabled-uplink” and “RTCP enabled”. Alternatively, RTCP may be assumed to be always on as long as the flow exists, and consequently the status of RTCP may not be indicated. PCRF 108 informs the PCEF 110 of the multiplexed RTP and RTCP accordingly. PCEF 110 may thereafter detects the multiplexed flows by the IP addresses and port numbers, as per current specifications, and detects the multiplexed subcomponents (RTP and RTCP) by the RTP parameters, for example the RTP payload type or RTCP packet type. PCEF 110 applies separate gating to data packets and control packets according to the status of each subcomponent. PCEF 110 applies policy and charging control separately to the RTP and RTCP flow(s) where applicable.

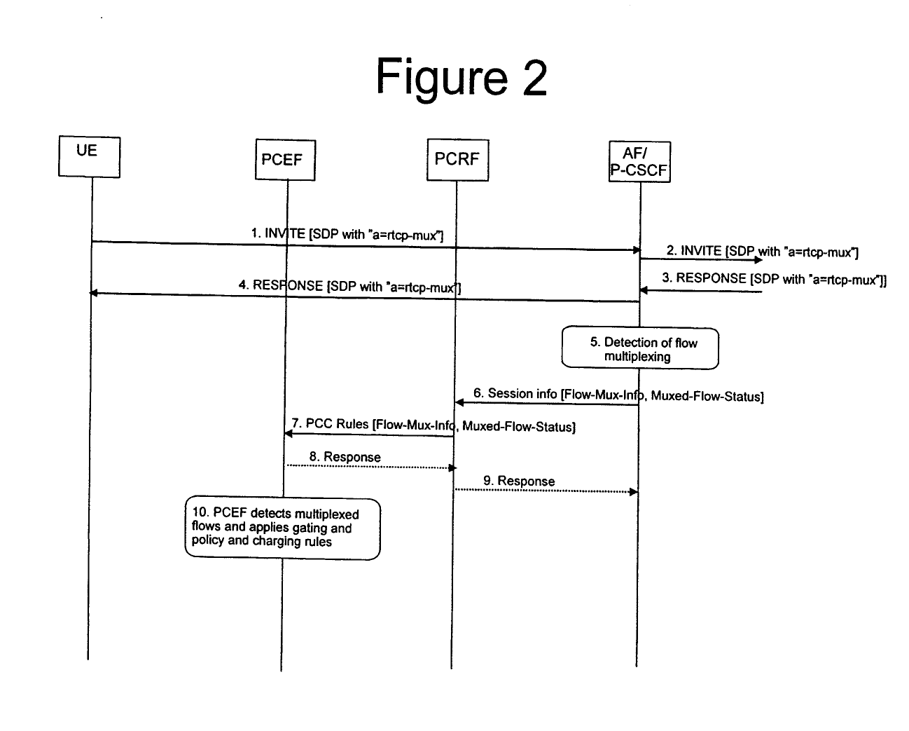

FIG. 2 illustrates an embodiment of a signalling scenario of a session establishment with flow multiplexing. In Step 1, the user equipment sends a SIP INVITE message with the SDP indicating flow multiplexing. In Step 2, AF/P-CSCF 106 sends the INVITE towards the called party. In Step 3, AF/P-CSCF 106 receives a SIP response message with the SDP indicating flow multiplexing. In Step 4, AF/P-CSCF 106 sends the SIP response towards the user equipment. In Step 5, AF/P-CSCF 106 detects that the SIP clients have agreed on multiplexing RTCP and RTP on the same port. In Step 6, AF/P-CSCF 106 sends session information with flow multiplexing information and multiplexed flow status information to PCRF 108. In Step 7, PCRF 108 sends policy and charging rules with flow multiplexing information and multiplexed flow status information to PCEF 110. In Steps 8 and 9, possible response messages are sent from PCEF 110 and PCRF 108. In Step 10, PCEF 110 detects multiplexed flows and applies gating and policy and charging rules. Thereafter, when a session or a flow of an ongoing session is put on hold, the real time control packet flow(s) is/are left active and only the real time data packet flow(s) is/are put made inactive by using the new RTCP and RTP multiplexing specific parameters.

The signalling embodiment shown in FIG. 2 may also apply as follows. AF/P-CSCF 106 recognizes the “a=rtcp−mux” attribute in the SDP. In the diameter based Rx interface between AF/P-CSCF 106 and PCRF 108, a new value is defined for the Flow-Usage Attribute-Value Pair (AVP) to indicate that the flow is a multiplexed flow and a new AVP is defined to indicate the status of the subcomponents (RTP, RTCP) of a multiplexed flow. Alternatively, new values are defined for the current Flow-Status AVP to indicate the status of the subcomponents (RTP, RTCP) of a multiplexed flow. AF/P-CSCF 106 forwards the flow information to PCRF 110 in relevant Diameter message(s). In the Diameter based Gx interface between PCRF 108 and PCEF 110, similar additions are made as those made for the Rx interface above. PCEF 110 uses the new parameters and/or parameter values to detect multiplexed flows and applies gating and/or policy and charging control accordingly.

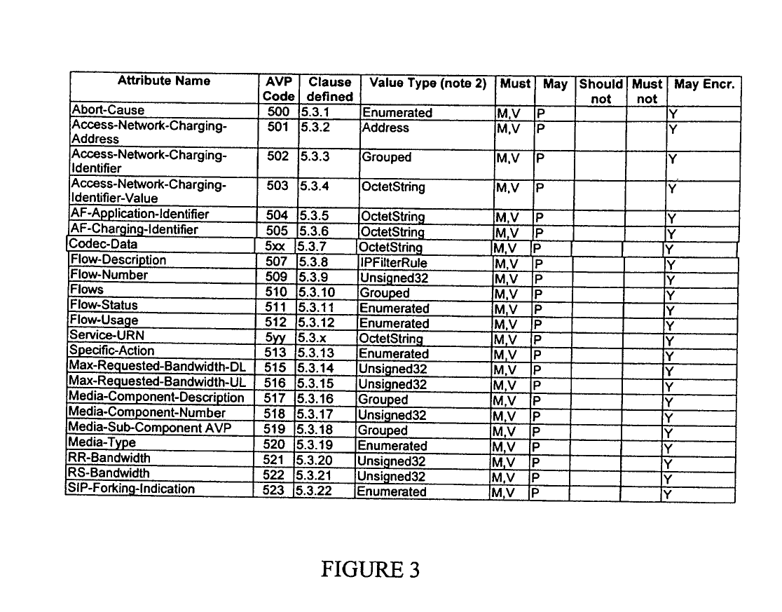

FIG. 3 illustrates an embodiment of the Diameter AVPs defined for the Rx interface protocol, their AVP Code values, types, possible flag values and whether or not the AVP may be encrypted. Specifically, the Flow-Status AVP (AVP code 511) is of type enumerated, and describes whether the IP flow(s) are enabled or disabled. The values for the Flow-Status AVP include ENABLED-UPLINK (0) which is used for indicating whether to enable associated uplink IP flow(s) and to disable associated downlink IP flow(s), ENABLED-DOWNLINK (1) which is used for indicating whether to enable associated downlink IP flow(s) and to disable associated uplink IP flow(s), ENABLED (2) which is used for indicating whether to enable all associated IP flow(s) in both directions, DISABLED (3) which is used for indicating whether to disable all associated IP flow(s) in both directions and REMOVED (4) which is used for indicating whether to remove all associated IP flow(s), wherein the IP Filters for the associated IP flow(s) are removed and the associated IP flows are not to be taken into account when deriving the authorized QoS.

The Flow-Usage AVP (AVP code 512) is of type enumerated, and provides information about the usage of IP Flows. The values for the Flow-Usage AVP include NO_INFORMATION (0) for indicating that no information about the usage of the IP flow is being provided, RTCP (1) for indicating that an IP flow is used to transport RTCP, AF_SIGNALLING (2) for indicating that the IP flow is used to transport AF Signalling Protocols (e.g. SIP/SDP). The value NO_INFORMATION is the default value.

It should be noted that future terminals supporting the multiplexing feature being specified by IETF can be supported by the 3GPP core IP multimedia subsystem.

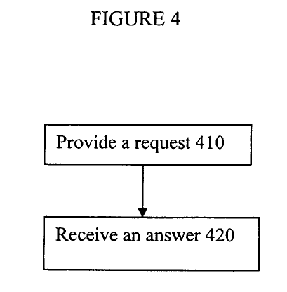

FIG. 4 illustrates a flow chart including providing a request including a predefined attribute to indicate real time protocol data packets or control packets that are to be multiplexed onto a single port. At step 410, a request including a predefined attribute to indicate real time protocol data packets and control packets to be multiplexed onto a single port is provided. At step 420, an answer indicating that multiplexed real time protocol data packets and control packets are to be processed according to the predefined attribute is received.

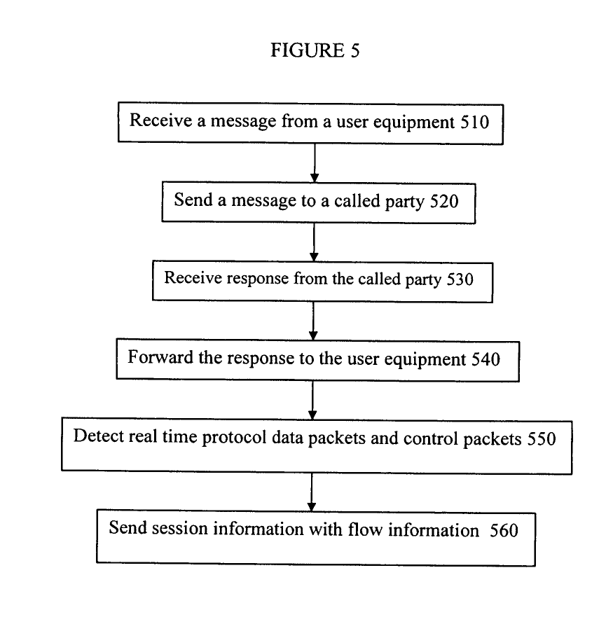

FIG. 5 illustrates a flow chart including receiving a request message indicating flow multiplexing from a user equipment, in accordance with and embodiment of the present invention. At step 510, a request message that indicates flow multiplexing is received from a user equipment. At step 520, the request message is sent to a called party. At step 530, a response message from the called party indicating flow multiplexing is received. At step 540, the response message is forwarded to the user equipment. At step 550, real time protocol data packets and control packets to be multiplexed on a single port are detected. At step 560, session information with flow multiplexing information and multiplexed flow status information are sent to a rules function to apply gating and policy and charging rules.

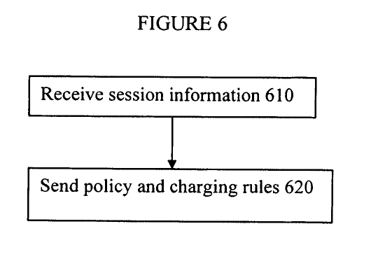

FIG. 6 illustrates a flow chart including receiving session information with flow multiplexing information and multiplexed flow status information from an application function. At step 610, session information with flow multiplexing information and multiplexed flow status information from an application function is received. At step 620, policy and charging rules with flow multiplexing information and multiplexed flow status information are sent to an enforcement function.

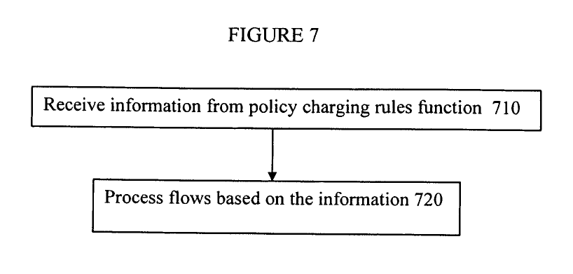

FIG. 7 illustrates a flow chart including receiving information from policy charging rules function. At step 710, information is received from policy charging rules function. At step 720, flows are processed based on the information, and the information comprises information differentiating real time protocol and real time control protocol within a multiplexed flow.

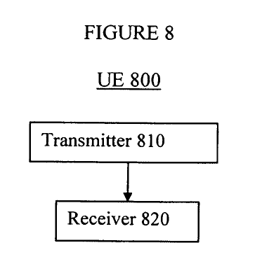

FIG. 8 illustrates an apparatus, in accordance with an embodiment of the present invention. A UE 800 may include a transmitter 810 and a receiver 820. A transmitter 810 is configured to send a request comprising a predefined attribute to indicate real time protocol data packets and control packets to be multiplexed onto a single port. A receiver 820 is configured to receive an answer indicating that multiplexed real time protocol data packets and control packets are to be processed according to the predefined attribute. The multiplexed real time protocol data packets and the control packets depend on a unicast session or multicast session.

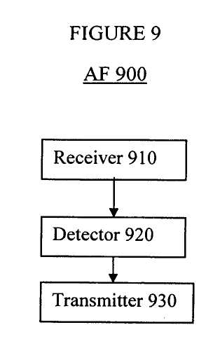

FIG. 9 illustrates an apparatus, in accordance with an embodiment of the present invention. An AF 900 may include a receiver 910, a detector 920, and a transmitter 930. A receiver 910 is configured to receive a request message indicating flow multiplexing from a user equipment. A transmitter 930 is configured to transmit the request message to a called party. The receiver 910 is configured to receive a response message from the called party indicating flow multiplexing. The transmitter 930 is configured to send the response message to the user equipment. A detector 820 is configured to detect real time protocol data packets and control packets to be multiplexed on a single port. The transmitter 930 is configured to send session information with flow multiplexing information and multiplexed flow status information to a rules function to apply gating and policy and charging rules.

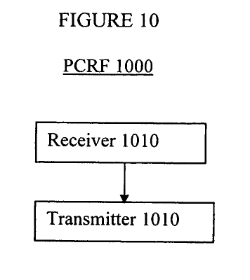

FIG. 10 illustrates an apparatus, in accordance with an embodiment of the present invention. A PCRF 1000 may include a receiver 1010 and a transmitter 1020. A receiver 1010 is configured to receive session information with flow multiplexing information and multiplexed flow status information from an application function. A transmitter 1020 is configured to send policy and charging rules with flow multiplexing information and multiplexed flow status information to an enforcement function.

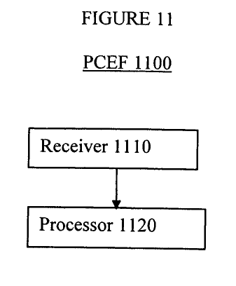

FIG. 11 illustrates an apparatus, in accordance with an embodiment of the present invention. A PCEF 1100 may include a receiver 1110 and a processor 1120. A receiver 1110 is configured to receive information from policy charging rules function. A processor 1120 is configured to process flows based on the information. The information comprises information differentiating real time protocol and real time control protocol within a multiplexed flow.

In accordance with an embodiment of the present invention, a computer program embodied on a computer readable medium can also be provided, encoding instructions for performing at least the method described in FIGS. 4-7 in accordance with an embodiment of the present invention.

The computer program product can be implemented in hardware, software, or a hybrid implementation. The computer program product can be comprised of modules that are in operative communication with one another, and which are designed to pass information or instructions to a communications device such as a user equipment or network node. The computer program product can be configured to operate on a general purpose computer or an application specific integrated circuit (ASIC).

In accordance with an embodiment of the present invention, network elements may by any device that utilizes network data, and can include switches, routers, bridges, gateways or servers. With respect to an embodiment of the present invention, various network elements such as computers (fixed or portable), mobile stations, mobile telephones, and personal data assistants or organizers are known to those skilled in the art which may be used as a user equipment (UE).

In addition, while the term data may be used in the description of the present invention, the invention has relevance to many types of network data. For purposes of this application, the term data includes packet, cell, frame, datagram, bridge protocol data unit packet, packet data and any equivalents thereof.

The many features and advantages of the invention are apparent from the detailed specification, and thus, it is intended by the appended claims to cover all such features and advantages of the invention which fall within the true spirit and scope of the invention. Further, since numerous modifications and changes will readily occur to those skilled in the art, it is not desired to limit the invention to the exact construction and step illustrated and described, and accordingly all suitable modifications and equivalents may be resorted to, falling within the scope of the invention.

What is claimed:

1. A method, comprising:
providing a request comprising a predefined attribute to indicate real time protocol data packets and control packets to be multiplexed onto a single port; and
receiving an answer indicating that multiplexed real time protocol data packets and control packets are to be processed according to the predefined attribute.

2. The method according to claim 1, wherein the multiplexed real time protocol data packets and the control packets depend on a unicast session or a multicast session.

3. The method according to claim 2, wherein the multicast session depends on a source multicast or a single source multicast.

4. The method according to claim 2, wherein the unicast session or the multicast session is signaled using the session initiation protocol.

5. An apparatus, comprising:
a transmitter configured to send a request comprising a predefined attribute to indicate real time protocol data packets and control packets to be multiplexed onto a single port; and
a receiver configured to receive an answer indicating that multiplexed real time protocol data packets and control packets are to be processed according to the predefined attribute.

6. The apparatus according to claim 5, wherein the multiplexed real time protocol data packets and the control packets depend on a unicast session or a multicast session.

7. The apparatus according to claim 6, wherein the multicast session depends on a source multicast or a single source multicast.

8. The apparatus according to claim 6, wherein the unicast session or the multicast session is signaled using the session initiation protocol.

9. The apparatus according to claim 5, wherein the apparatus comprises a user equipment.

10. A computer program embodied on a computer readable medium, the computer program being configured to control a processor to perform:
providing a request comprising a predefined attribute to indicate real time protocol data packets and control packets to be multiplexed onto a single port; and
receiving an answer indicating that multiplexed real time protocol data packets and control packets are to be processed according to the predefined attribute.

11. An apparatus, comprising:
sending means for sending a request comprising a predefined attribute to indicate real time protocol data packets and control packets to be multiplexed onto a single port; and
receiving means for receiving an answer indicating that multiplexed real time protocol data packets and control packets are to be processed according to the predefined attribute.

12. A method, comprising:
receiving a request message indicating flow multiplexing from a user equipment;
sending the request message to a called party;
receiving a response message from the called party indicating flow multiplexing;
forwarding the response message to the user equipment;
detecting real time protocol data packets and control packets to be multiplexed on a single port; and
sending session information with flow multiplexing information and multiplexed flow status information to a rules function to apply gating and policy and charging rules.

13. The method according to claim 12, wherein the method offers applications that require dynamic policy and/or charging control over a user plan behavior.

14. An apparatus, comprising:
a receiver configured to receive a request message indicating flow multiplexing from a user equipment;
a transmitter configured to transmit the request message to a called party,
wherein the receiver is configured to receive a response message from the called party indicating flow multiplexing, and
wherein the transmitter is configured to the response message to the user equipment;
a detector configured to detect real time protocol data packets and control packets to be multiplexed on a single port,
wherein the transmitter is configured to send session information with flow multiplexing information and multiplexed flow status information to a rules function to apply gating and policy and charging rules.

15. The apparatus according to claim 14, wherein the apparatus comprises an application function or a call state control function.

16. The apparatus according to claim 15, wherein the application function is an element offering applications that require dynamic policy and/or charging control over a user plan behavior.

17. A computer program embodied on a computer readable medium, the computer program being configured to control a processor to perform:
receiving a request message indicating flow multiplexing from a user equipment;
sending the request message to a called party;
receiving a response message from the called party indicating flow multiplexing;
forwarding the response message to the user equipment;
detecting real time protocol data packets and control packets to be multiplexed on a single port; and
sending session information with flow multiplexing information and multiplexed flow status information to a rules function to apply gating and policy and charging rules.

18. An apparatus, comprising:
receiving means for receiving a request message indicating flow multiplexing from a user equipment;
sending means for sending the request message to a called party,
wherein the receiving means receives a response message from the called party indicating flow multiplexing;
forwarding means for forwarding the response message to the user equipment; and
detecting means for detecting real time protocol data packets and control packets to be multiplexed on a single port,
wherein the sending means sends session information with flow multiplexing information and multiplexed flow status information to a rules function to apply gating and policy and charging rules.

19. A method, comprising:
receiving session information with flow multiplexing information and multiplexed flow status information from an application function; and
sending policy and charging rules with flow multiplexing information and multiplexed flow status information to an enforcement function.

20. The method according to claim 19, wherein the method is performed by a policy charging rules function.

21. The method according to claim 20, wherein policy charging rules function comprises policy control decision and flow based charging control functions.

22. An apparatus, comprising:
a receiver configured to receive session information with flow multiplexing information and multiplexed flow status information from an application function; and
a transmitter configured to send policy and charging rules with flow multiplexing information and multiplexed flow status information to an enforcement function.

23. The apparatus according to claim 22, wherein the apparatus comprises a policy charging rules function.

24. The apparatus according to claim 23 wherein policy charging rules function comprises policy control decision and flow based charging control functions.

25. A computer program embodied on a computer readable medium, the computer program being configured to control a processor to perform:
receiving session information with flow multiplexing information and multiplexed flow status information from an application function; and
sending policy and charging rules with flow multiplexing information and multiplexed flow status information to an enforcement function.

26. An apparatus, comprising:
receiving means for session information with flow multiplexing information and multiplexed flow status information from an application function; and
sending means for sending policy and charging rules with flow multiplexing information and multiplexed flow status information to an enforcement function.

27. A method, comprising:
receiving information from policy charging rules function; and
processing flows based on the information,
wherein the information comprises information differentiating real time protocol and real time control protocol within a multiplexed flow.

28. The method according to claim 27, wherein the processing flows comprises detecting the multiplexed flows.

29. The method according to claim 27, wherein the processing flows comprises applying gating and policy and charging rules.

30. The method according to claim 29, wherein the gating is directed to the blocking or allowing packets belonging to a service data flow to pass through to a desired endpoint.

31. An apparatus, comprising:
a receiver configured to receive information from policy charging rules function; and
a processor configured to process flows based on the information,
wherein the information comprises information differentiating real time protocol and real time control protocol within a multiplexed flow.

32. The apparatus according to claim 31, wherein the processing flows comprises detecting multiplexed flows.

33. The apparatus according to claim 31, wherein the processing flows comprises applying gating and policy and charging rules.

34. The apparatus according to claim 33, wherein the gating is directed to the blocking or allowing packets belonging to a service data flow to pass through to a desired endpoint.

35. The apparatus according to claim 31, wherein the apparatus comprises a policy charging enforcement function.

36. A computer program embodied on a computer readable medium, the computer program being configured to control a processor to perform:
receiving information from policy control rules function; and
processing flows based on the information,
wherein the information comprises information differentiating real time protocol and real time control protocol within a multiplexed flow.

37. An apparatus, comprising:
receiving means for receiving information from policy control rules function; and
processing means for processing flows based on the information,
wherein the information comprises information differentiating real time protocol and real time control protocol within a multiplexed flow.

38. A system, comprising:
an application function configured to indicate per each multiplexed flow to a rules function that a flow includes multiplexed real time protocol data packets and control packets flow and to indicate the status of a component of the multiplexed flow,
wherein the rules function is configured to inform an enforcement function which is configured to detect the multiplexed flows by internet protocol addresses and port numbers and to detect the multiplexed subcomponents, and
wherein the enforcement function is configured to apply separate gating to data packets and control packets according to the status of each subcomponent.
